(19) United States
(12) Patent Application Publication
(10) Pub. No.: US 2024/0020757 A1
(43) Pub. Date: Jan. 18, 2024

(54) SYSTEM, METHOD, AND COMPUTER PROGRAM FOR QUANTIFYING THE PRIMACY OF A FINANCIAL RELATION

(71) Applicant: Yodlee, Inc., San Mateo, CA (US)

(72) Inventors: Ambar Bandyopadhyay, Kolkata (IN); Om D. Deshmukh, Bangalore (IN); Pramod Singh, Apex, NC (US); Priyanka Sawant, Indore (IN); Vinay Manjunath, Bangalore (IN)

(21) Appl. No.: 17/865,252

(22) Filed: Jul. 14, 2022

(51) Int. Cl. G06Q 40/02

(52) U.S. Cl. CPC G06Q 40/02

(57) ABSTRACT

As described herein, a system, method, and computer program are provided for quantifying the primacy of a financial relation for financial institution account management. An account of a customer with a financial institution is identified. Transactional-related information for the account is accessed. A holistic primacy score is computed for the account, using the transactional-related information, where the holistic primacy score holistically quantifies a primacy relation of the customer with the financial institution. At least one action is caused to be performed in association with the account, based on the holistic primacy score.

### FIELD OF THE INVENTION

The present invention relates to financial institution account management.

### BACKGROUND

A financial institution (e.g. a bank) is said to have a primacy relation with an account holder if the financial institution is the preferred and the main financial institution partner for that account holder. One conventional way to quantify the primacy is to figure out what percentage of the overall financial needs of the account holder are met through the current financial institution versus through any other financial institution.

Quantifying primacy of an account holder meets several different business needs of a financial institution. For example, a financial institution will want to quantify the cost of servicing an account versus the net business the account is providing and extrapolate it to the long-term value of the account holder who potentially has multiple accounts with the financial institution. The financial institution may have different strategies for different primacy accounts: for instance, accounts with high primacy may be given the first preference for trying out the latest tech product or may get a preferential treatment at the customer interaction touch points. The financial institution may make specific outreach and engagement efforts to convert the mid primacy account into high primacy accounts. Knowing what kind of accounts are low-primacy may help a financial institution profile the kind of accounts who are not their base customers and then plan their next products/strategies accordingly. The definition of primacy can also change from time to time: for instance, in the pre-launch phase of a new type of credit card, the financial institution may want to know which accounts use the financial institution as the primary credit card account in contrast to which accounts use the checking account of the financial institution to regularly pay off credit cards issued by other financial institutions.

Traditionally, primacy is computed either as a function of the number of transactions the particular account has seen and/or as a function of the total dollar amount transacted by the account over a given period of time. Such simple computations do not enable personalized actionable insights mentioned above for various account holders. There is thus a need for addressing these and/or other issues associated with the prior art.

### SUMMARY

As described herein, a system, method, and computer program are provided for quantifying the primacy of a financial relation for financial institution account management. An account of a customer with a financial institution is identified. Transactional-related information for the account is accessed. A holistic primacy score is computed for the account, using the transactional-related information, where the holistic primacy score holistically quantifies a primacy relation of the customer with the financial institution.

In an embodiment, this holistic primacy score is a combination of several components such as the diversity of various banking features the account uses, the nature of the interactions the account has with the banking institution, use of technology while interacting with the banking institution, and a few others. In an embodiment, based on the holistic primacy score and the relative value of the individual components that contribute to the holistic primacy score, the most appropriate next action(s) is/are recommended to the banking executive who is managing the banking account. Examples of the next best actions are: send loan consolidation offers to users with mid-to-high holistic primacy score but who also have high interactions with other financial institutions, or upgrade those account holders to the latest tech-embedded debit card who have high holistic primacy score and have high propensity of using technology.

### BRIEF DESCRIPTION OF THE DRAWINGS

FIG. 1 illustrates a method for quantifying the primacy of a financial relation for financial institution account management, in accordance with one embodiment.

FIG. 2 illustrates a method for computing a holistic primacy score for a customer's account with a financial institution, in accordance with one embodiment.

FIG. 3 illustrates a network architecture, in accordance with one possible embodiment.

FIG. 4 illustrates an exemplary system, in accordance with one embodiment.

### DETAILED DESCRIPTION

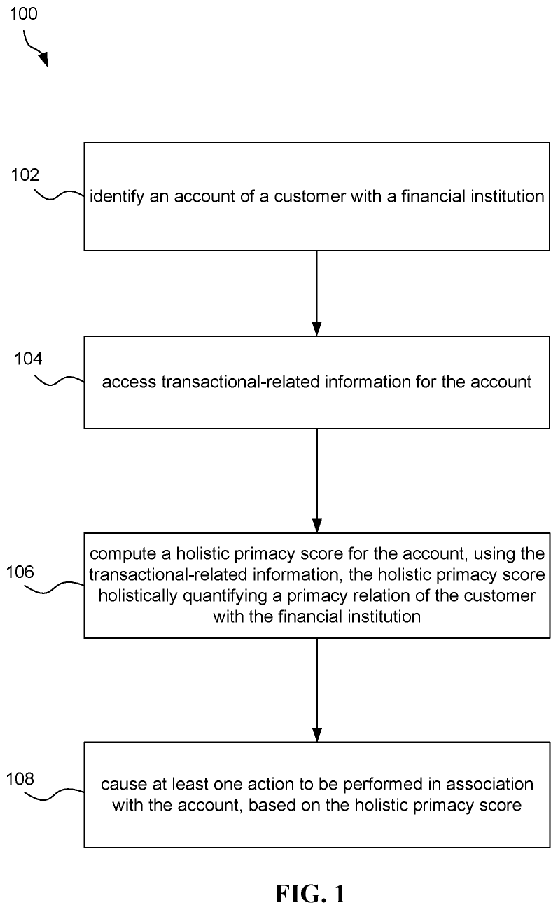

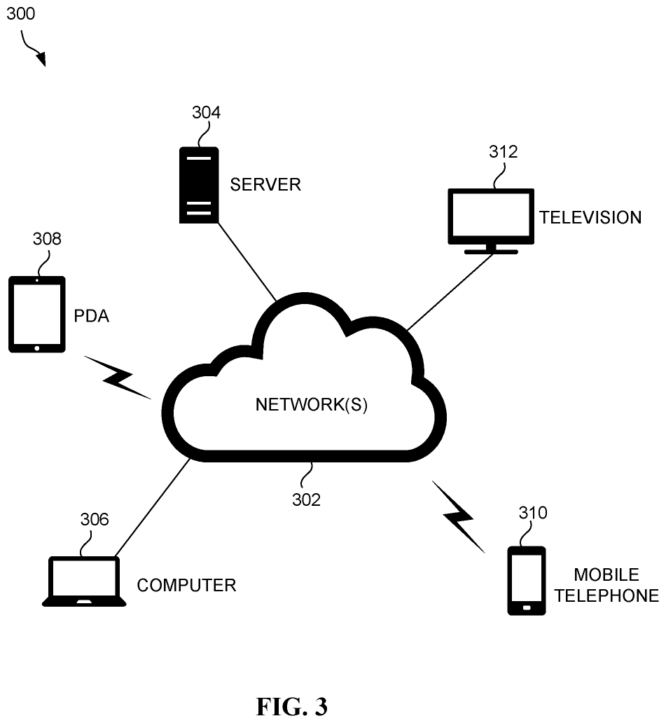

FIG. 1 illustrates a method for quantifying the primacy of a financial relation for financial institution account management, in accordance with one embodiment. The method 100 may be performed by any computer system, such as those described below with respect to FIGS. 3 and/or 4. For example, in one embodiment, the method 100 may be performed by a computer system interfacing a system of one or more financial institutions that generate financial transaction data based on the financial transactions of its customers (e.g. users, business entities, etc.), among other data systems. The computer system performing the method 100 may be a sub-system of one of the financial institutions, in another embodiment.

The method 100 is performed to quantify the primacy of a relation of an account with a financial institution, for use in account management. In the context of the present description, a “financial institution” refers to any entity that facilitates financial transactions for its customers, such as a banking entity. A financial transaction may be a monetary deposit, monetary withdrawal, monetary transfers, or any other transaction involving money.

In operation 102, an account of a customer with a financial institution is identified. The account may be any type of account by which the customer is able to participate in financial transactions, such as a banking account, a credit card account, etc. The account may be identified using a unique identifier of the account, in one embodiment. In another embodiment, the account may be identified from a plurality of customer accounts held with the financial institution.

In operation 104, transactional-related information for the account is accessed. The transactional-related information includes any information related to the financial transactions involving the account of the customer. For example, the transactional-related information may include records of historical financial transactions performed in association with the account. The historical financial transaction records may be made accessible by the financial institution which keeps such records for its customers.

In one embodiment, the transactional-related information may include a category label assigned to each of the historical financial transactions, for example to label each of the historical financial transactions as a credit transaction of the category “Salary/Regular Income”, or a debit transaction of the category “Rent”, etc. Other data included in each of the historical financial transaction records may include a date of the financial transaction, an amount of money involved in the financial transaction, a recipient of the financial transaction when the customer is the initiator of the financial transaction, an initiator of the financial transaction when the customer is the recipient of the financial transaction, or any other data describing an aspect of the financial transaction.

In operation 106, a holistic primacy score is computed for the account, using the transactional-related information, where the holistic primacy score holistically quantifies a primacy relation of the customer with the financial institution. With respect to the present description, a primacy relation of the customer with the financial institution refers to a preference of the customer to use the financial institution for financial transactions. Accordingly, quantifying the primacy relation of the customer with the financial institution refers to generating a measure, or other computed indicator, according to some defined scale which defines the degree to which the customer prefers to use the financial institution for financial transactions.

In an embodiment, this holistic primacy score is a combination of several components such as the diversity of various banking features the account uses, the nature of the interactions the account has with the banking institution, use of technology while interacting with the banking institution, and a few others. The holistic primacy score may be computed from various components derived from the transactional-related information. In one embodiment, the holistic primacy score may be computed based on a quantification of diverse banking features of the financial institution that the customer engages with via the account. In another embodiment, the holistic primacy score may be computed based on a quantification of the various categories of transactions for which the account is used.

In yet another embodiment, the holistic primacy score may be computed based on a completeness score determined from an inferred probability that each particular category of transaction is likely to be included in the transactional-related information for the account. Such probability may be inferred using a machine learning algorithm. In still yet another embodiment, the holistic primacy score may be computed based on a quantification of any additional financial institutions included in the transactional-related information for the account.

Further, the holistic primacy score may be computed based on multiplicative factors. The multiplicative factors may scale a primacy score determined from the component(s) mentioned above to compute the holistic primacy score. In an embodiment, the holistic primacy score may be computed based on a technology centricity score calculated for the account. In another embodiment, the holistic primacy score may be computed based on cohort benchmarking of a total dollar transaction amount for the account. In yet another embodiment, the holistic primacy score may be computed based on a proportion of dollar amount transacted on each particular category by the account.

In one exemplary implementation, the holistic primacy score may be computed using Equation 1.

holistic primacy score=(D+R+C+F)*(α*β*γ) Equation 1
where D is a quantification of diverse banking features of the financial institution that the customer engages with via the account,
where R is a quantification the various categories of transactions for which the account is used,
where C is a completeness score determined from an inferred probability that each particular category of transaction is likely to be included in the transactional-related information for the account,
where F is a quantification of any additional financial institutions included in the transactional-related information for the account,
where α is a technology centricity score calculated for the account,
where β is a cohort benchmarking of a total dollar transaction amount for the account, and
where γ is a proportion of dollar amount transacted on each particular category by the account.

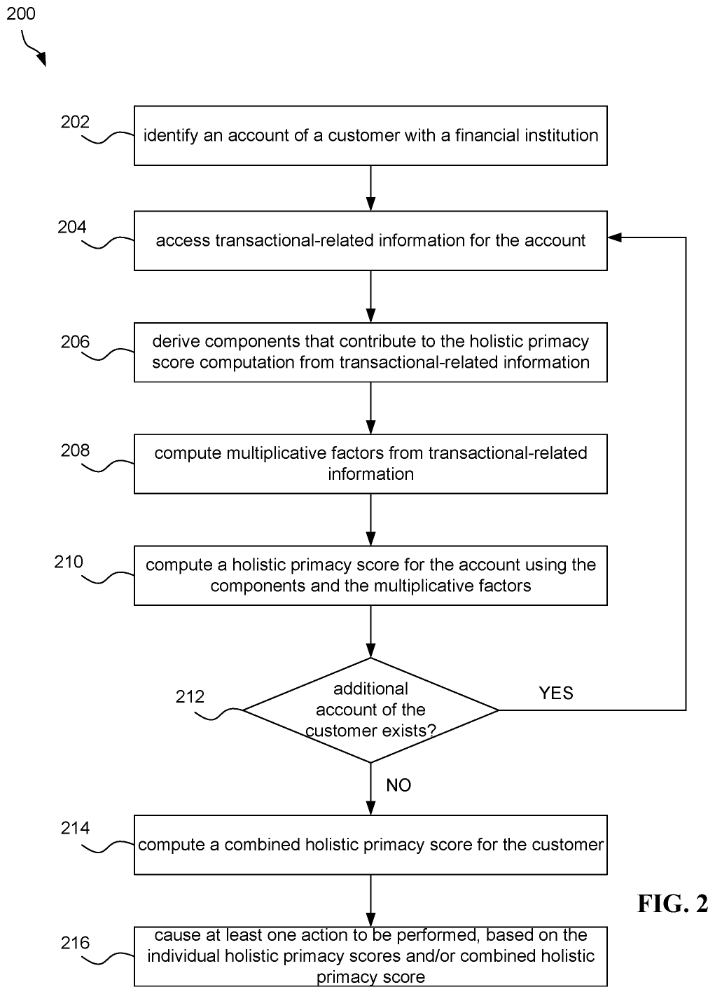

Various details related to the components and multiplicative factors mentioned above will be provided below with reference to FIG. 2.

In operation 108, at least one action is caused to be performed in association with the account, based on the holistic primacy score. The action(s) may be a function or process that is automatically performed in association with the account, based on the holistic primacy score. Causing the action(s) to be performed may include locally performing the action(s) or instructing a remote system to perform the action(s) such that the action(s) are performed remotely.

In an embodiment, different actions, or sets of actions, may be predefined for different holistic primacy scores or for different ranges of holistic primacy scores. In this embodiment, the action(s) that are caused to be performed in association with the account may be predefined for the holistic primacy score computed for the account. Of course other factors may also be considered when determine which action(s) are to be performed, such as existing financial products subscribed to by the account, a geographical location of the customer, financial products available to the account, etc.

Just by way of example, the at least one action may include prioritizing the customer for receiving one or more new product offers of the financial institution (e.g. where the new product offers are selected according to the holistic primacy scores and possibly other factors). As another example, the at least one action may include giving the customer preferential treatment at customer interaction touch points of the financial institution (e.g. when contacting customer service of the financial institution).

In an embodiment, based on the holistic primacy score and the relative value of the individual components that contribute to the holistic primacy score, the most appropriate next action(s) can be recommended (e.g. to the banking executive who is managing the banking account, or to an automated process). Examples of the next best actions are: send loan consolidation offers to users with mid-to-high holistic primacy score but who also have high interactions with other financial institutions, or upgrade those account holders to the latest tech-embedded debit card who have high holistic primacy score and have high propensity of using technology.

In an optional embodiment, the method 100 may further determine whether the customer has any additional accounts with the financial institution. In this embodiment, the holistic primacy score may be computed for each of the additional accounts. Further, a combined holistic primacy score may be computed for all accounts of the customer with the financial institution, using combined transactional-related information for all of the accounts. Such combined transactional-related information may exclude transactions that occurred between two of the accounts of the customer.

Still yet, at least one additional action, such as those mentioned above, may be performed in association with the customer, based on the combined holistic primacy score. For example, the additional action(s) may be performed for the customer as a whole (e.g. independent of the customer's existing accounts with the financial institution), or for select ones of the customer's accounts, based on the combined holistic primacy score.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a method 200 for computing a holistic primacy score for a customer's account with a financial institution, in accordance with one embodiment. As an option, the method 200 may be carried out in the context of the details of the previous figure and/or any subsequent figure(s). Of course, however, the method 200 may be carried out in the context of any desired environment. Further, the aforementioned definitions may equally apply to the description below.

In operation 202, an account of a customer with a financial institution is identified. In operation 204, transactional-related information for the account is accessed. In one embodiment, a transaction categorization engine may assign a category label to each of the financial transactions in the transactional-related information. Optionally, account cohorts may also be created based on the account activity indicated in the transactional-related information.

In operation 206, components that contribute to the holistic primacy score computation are derived from the transactional-related information. The types of components that are derived, and the functions for deriving them, are predefined.

In one embodiment, the components include a quantification of diverse banking features of the financial institution that the customer engages with via the account. This component quantifies the diverse banking features that the account holder engages with. Note that while banking features are different from the banking products, there is a certain hierarchy in the sense that certain features are logical only for certain banking products. For instance, a checking account is a financial product which may have features like a web-based checkbook request, no-fee ATM withdrawals, mobile-based check deposit and so on. Similarly, a credit card is a banking product which may have features like the dollar limit on the card, cashback rewards vs exclusive shopping experiences through the card, the APR on the card and so on. Some of the features that may be considered are: (a) ATM withdrawals, (b) check deposits and check issuance, (c) wire transfers and ACH transfers, (d) various fees paid or charged-and-waived (like a minimum balance amount fees that is charged and later waived), (e) automated recurring activities like subscription payments, (f) in-branch visits, (g) tier of exclusivity of a credit card (for simplicity, each card is assigned one of three tiers: premium, general and aspirational, and as the names suggest, premium cards have low APR, high dollar limits and likely more exclusivity, whereas the aspirational cards are either prepaid or with low limits and high APR), and/or (h) outstanding balance consolidation.

Each feature is quantified along two dimensions: (i) frequency of transactions related to that feature, (ii) dollar amounts of the transactions related to that feature. The quantification is based on statistics such as the overall average for a given duration, variations across monthly averages, standard deviations for the given duration and across the months.

Further, these quantifications are normalized using two references: (i) the corresponding global numbers across the entire account population in consideration (e.g. if we are analyzing Automated Clearing House (ACH) transfers across a population of users we would compute the statistics across these 10 M accounts and normalize each specific account as very-low/low/mid/high/very-high depending on that account's ACH transfer behavior relative to these stats), and (ii) relative to the specific account (e.g. if the average number of overall transactions per month for this account is 150 and the average number of eat-out related monthly transactions is 45, then this normalization would make the eat-out transactions as 0.3). Finally, these normalized values across all the features are combined in a weighted fashion. Equation 2 below provides one such example.

$$D = {\sum }_{i = 1}^{N} {f}_{i} * {w}_{i} \qquad Equation 2$$

where D is the quantified diversity relation,
fᵢ is a feature and wᵢ is the corresponding weight, and
N is the total number of features.

The weights can either be learned automatically or there is a provision for a human expert to assign specific weights for each of the features. There is also a provision to include more features in the computation (removing features is as simple as reducing their corresponding weights to zero). D (as used in Equation 2 above) is passed through a non-linear transformation to restrict its value to a 0-to-1 range.

In another embodiment, the components include a quantification the various categories of transactions for which the account is used. This component is different from the diversity of the relation mentioned above in a slight but significant way. This component quantifies the various categories for which the account is used. For instance, the component is based on what percentage of the account activity is for day-to-day financials like eat-out, commute, personal care vs for one-off big-ticket activities like an international vacation. There may be 500+ categories on the expense side (e.g. ‘spa visit;’, ‘Chinese restaurant’, ‘home improvement’, . . . ) and 15+ categories on the income side (e.g. ‘regular salary’, ‘refunds’, ‘check deposit’, . . . ) and so on. The transaction pattern for each of these categories is quantified in the same as for the diversity of the relation mentioned above. Let us denote this component as R (as used in Equation 1 above). R is passed through a non-linear transformation to restrict its value to a 0-to-1 range.

In yet another embodiment, the components include a completeness score determined from an inferred probability that each particular category of transaction is likely to be included in the transactional-related information for the account. There will be certain individuals who have no mortgage, not just with the current financial institution but with any other financial institution, and hence no monthly mortgage payments at all. Likewise, there may be certain individuals who do not use checks at all. Penalizing such users' primacy score for lack of transactional activity related to such categorizes is misleading. Machine learning algorithms may be used which compute probabilities that a particular category of transaction is likely to be seen for a given account. An intermediate step is to define a completeness index for every account: The completeness index is based on the following broad buckets of transactions: (a) income-related, (b) life-style expense related, (c) liabilities related (auto loan, home loan etc.), (d) coverage related (life insurance, home insurance etc.), and/or (e) investment related (savings, securities, retirement etc.). To create the ground truth for training the machine learning models, we first manually studied hundreds of accounts along the above-mentioned five buckets to assign a numeric completeness index. We also studied conditions which lead to lack of one or more of the above five buckets. For instance, an account with a more-than-average retirement income and less-than-average expense on kids-related-life-style categories is genuinely less likely to have a regular-salary-income. Such an account should have a high completeness index even in the absence of a regular-salary-income. Based on this data, we trained a feed forward neural network classifier which classifies an account as high/mid/low on completeness. An important byproduct of the classifier is a numeric value (in 0-to-1 range) of completeness for each of the five buckets. Let us denote the completeness index of the account as C (as used in Equation 1 above). C is passed through a non-linear transformation to restrict its value to a 0-to-1 range.

In still yet another embodiment, the components include a quantification of any additional financial institutions included in the transactional-related information for the account. This component is best explained with an example: Consider a situation where a credit-card payment goes out regularly from a particular account of a particular financial institution. If the credit card issuing financial institution is the same as the financial institution of the account, then the primacy score of that account for that FI has to increase as compared to the case where the credit issuing financial institution is not the same as the financial institution of the account. Further, the fact that the payment for the credit card is happening from this account should increase the primacy of the account (irrespective of which financial institution issued the credit card). Thus, there are two factors to be accounted for while quantifying this component. What makes is even more complicated is that we need to account for situations where there are multiple credit cards and the payments are also happening from multiple bank accounts. An intermediate normalization layer may be used which computes the normalization as mentioned in the diversity of the relation subsection above. For each category that is likely to involve more than one financial institution, we compute normalization for each unique pair of financial institutions and then combine these values across all the pair for a given category. Categories that have such multi-financial institution-involvement are: (a) credit card payment, (b) transfers, (c) check related, (d) loans, (e) insurance, (f) investments, (g) savings. To account for the two factors mentioned above, a probabilistic likelihood that a financial institution provides a given multi-financial institution-involvement product is computed (e.g., financial institution-A may have a 0.3 probability of providing any type of insurance product whereas financial institution-B may have a 0.65 probability of providing an insurance product). The probability is computed as a product of (a) a prior probability that our human experts provide based on their industry analysis, and (b) a data likelihood that we compute based on the proportion of accounts in our data that have a particular service from a particular financial institution. Let us denote this component for an account as F (as used in Equation 1 above). F is passed through a non-linear transformation to restrict its value to a 0-to-1 range.

In operation 208, multiplicative factors are computed from the transactional-related information. The types of multiplicative factors that are computed, and the functions for deriving them, are predefined. The multiplicative factors scale the primacy score to compute the holistic primacy score.

In one embodiment, the multiplicative factors include a technology centricity score calculated for the account (denoted as a in Equation 1 above). The assumption here is that, all else being same, the account with more technology usage should rank higher in primacy than other accounts. For instance, all else being the same, if account from financial institution-A is used in the context of a digi-wallet instead of an account from financial institution-B, then the account from financial institution-A should rank higher on the primacy score. The tech-centricity score is computed as a function of the proportion of the dollar amount transacted through tech channels versus the total dollar amount transacted in a given period.

In another embodiment, the multiplicative factors include cohort benchmarking of a total dollar transaction amount for the account (denoted as β in Equation 1 above). The assumption here is that, all else being the same, the higher the dollar amount that an account transacts as compared to the average amount for the account's peers the higher the primacy of that account. This is quantified as a simple proportion of the dollar amount of the account and the average dollar amount across the peers. The proportion is maximized at 2 (i.e., (3 can at the most be two and that happens when the total dollar amount an account has transacted is twice or more than the average dollar amount for the peers).

In yet another embodiment, the multiplicative factors include a proportion of dollar amount transacted on each particular category by the account (denoted as yin Equation 1 above). The assumption here is that, all else being the same, the higher proportion of dollar amount transacted on a particular category, the higher the primacy of that account for that category. For example, if account-A and account-B have the same purchasing power, but account-A spends 40% on loan-repayment and account-B spends only 5% on loan-payment then account-A is said to have higher primacy for the loan product.

In operation 210, a holistic primacy score is computed for the account, using the components and the multiplicative factors. Equation 1 (described above) may be used to compute the holistic primacy score for the account. Of course, other functions that use the components and the multiplicative factors as variables may be used to compute the holistic primacy score for the account.

In decision 212, it is determined whether an additional account of the customer with the financial institution exists. When it is determined that an additional account exists, the method 200 again performs operations 204-210 to compute a holistic primacy score for the additional account.

Once it is determined that no additional account of the customer with the financial institution exists, then in operation 214 a combined holistic primacy score is computed for the customer (in operation 210). Of course operation 214 may only be performed when multiple accounts of the customer with the financial institution exist.

It is quite common that a financial institution customer has more than one account with the financial institution. In such cases, we compute the holistic primacy score for each account separately and provide the individual account holistic primacy score as well as one combined holistic primacy score which is computed by treating the transactions from all of the accounts as if they belonged to a single account (i.e. by performing operations 204-210 with respect to the transactional-related information for all of the accounts). The only extra step is that transactions which are among these accounts of the customer are removed. For instance, a transfer from account-A to account-B will show as a debit transaction from account-A and as a credit transaction in account-B. We remove both these transactions before the combined holistic primacy score is computed.

In operation 216, at least one action is caused to be performed, based on the individual holistic primacy scores and/or the combined holistic primacy score. Quantifying the primacy of the account of the customer with regard to the financial institution (as the holistic primacy score of the account) and/or of the customer with regard to the financial institution (as the combined holistic primacy score) meets several different needs of a financial institution. A financial institution will want to quantify the cost of servicing an account versus the net business the account is providing and extrapolate it to the long-term value of the customer who potentially has multiple accounts with the financial institution.

The financial institution will have different strategies (i.e. next best actions) for different primacy accounts: for instance, accounts with high primacy (i.e. above a defined threshold) may be given the first preference for trying out the latest tech product or may get a preferential treatment at the customer interaction touch points. The financial institution may make specific outreach and engagement efforts to convert the mid primacy (i.e. within a defined low threshold and defined high threshold range) account into high primacy accounts. Knowing what kind of accounts are low-primacy (i.e. below a defined low threshold) may help a financial institution profile the kind of accounts who are not their base customers and then plan their next products/strategies accordingly. The definition of primacy can also change from time to time: for instance, in the pre-launch phase of a new type of credit card, the financial institution may want to know which accounts use the financial institution as the primary credit card account in contrast to which accounts use the checking account of the FI to regularly pay off credit cards issued by other financial institutions.

FIG. 3 illustrates a network architecture 300, in accordance with one possible embodiment. As shown, at least one network 302 is provided. In the context of the present network architecture 300, the network 302 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 302 may be provided.

Coupled to the network 302 is a plurality of devices. For example, a server computer 304 and an end user computer 306 may be coupled to the network 302 for communication purposes. Such end user computer 306 may include a desktop computer, lap-top computer, and/or any other type of logic. Still yet, various other devices may be coupled to the network 302 including a personal digital assistant (PDA) device 308, a mobile phone device 310, a television 312, etc.

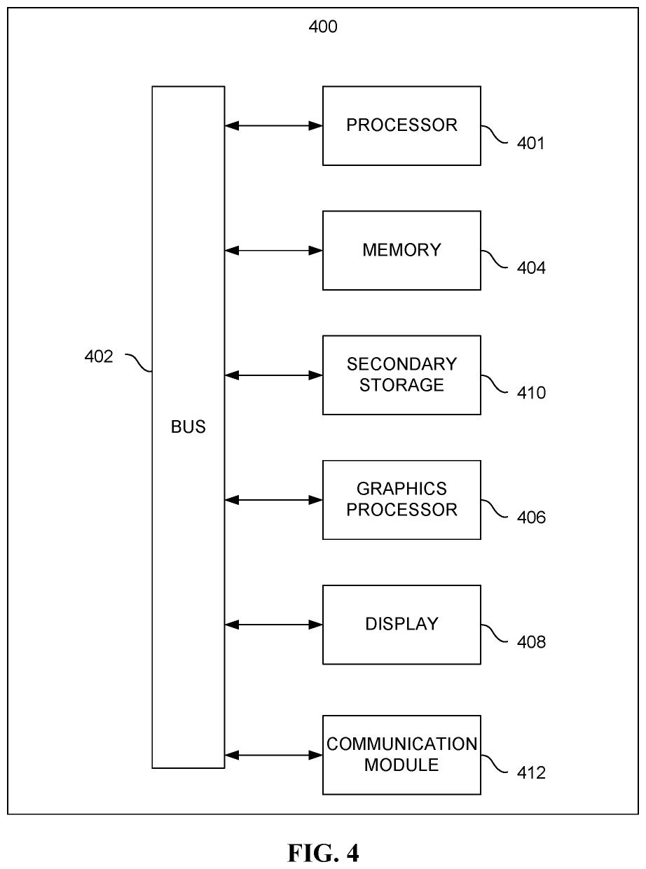

FIG. 4 illustrates an exemplary system 400, in accordance with one embodiment. As an option, the system 400 may be implemented in the context of any of the devices of the network architecture 300 of FIG. 3. Of course, the system 400 may be implemented in any desired environment.

As shown, a system 400 is provided including at least one central processor 401 which is connected to a communication bus 402. The system 400 also includes main memory 404 [e.g. random access memory (RAM), etc.]. The system 400 also includes a graphics processor 406 and a display 408.

The system 400 may also include a secondary storage 410. The secondary storage 410 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 404, the secondary storage 410, and/or any other memory, for that matter. Such computer programs, when executed, enable the system 400 to perform various functions (as set forth above, for example). Memory 404, storage 410 and/or any other storage are possible examples of non-transitory computer-readable media.

The system 400 may also include one or more communication modules 412. The communication module 412 may be operable to facilitate communication between the system 400 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
identify an account of a customer with a financial institution;
access transactional-related information for the account;
compute a holistic primacy score for the account, using the transactional-related information, the holistic primacy score holistically quantifying a primacy relation of the customer with the financial institution; and
cause at least one action to be performed in association with the account, based on the holistic primacy score.

2. The non-transitory computer-readable media of claim 1, wherein the transactional-related information for the account includes records of historical financial transactions performed in association with the account.

3. The non-transitory computer-readable media of claim 2, wherein the transactional-related information includes a category label assigned to each of the historical financial transactions.

4. The non-transitory computer-readable media of claim 1, wherein the holistic primacy score is computed based on a quantification of diverse banking features of the financial institution that the customer engages with via the account.

5. The non-transitory computer-readable media of claim 1, wherein the holistic primacy score is computed based on a quantification the various categories of transactions for which the account is used.

6. The non-transitory computer-readable media of claim 1, wherein the holistic primacy score is computed based on a completeness score determined from an inferred probability that each particular category of transaction is likely to be included in the transactional-related information for the account.

7. The non-transitory computer-readable media of claim 6, wherein the probability is inferred using a machine learning algorithm.

8. The non-transitory computer-readable media of claim 1, wherein the holistic primacy score is computed based on a quantification of any additional financial institutions included in the transactional-related information for the account.

9. The non-transitory computer-readable media of claim 1, wherein the holistic primacy score is computed based on a technology centricity score calculated for the account.

10. The non-transitory computer-readable media of claim 1, wherein the holistic primacy score is computed based on cohort benchmarking of a total dollar transaction amount for the account.

11. The non-transitory computer-readable media of claim 1, wherein the holistic primacy score is computed based on a proportion of dollar amount transacted on each particular category by the account.

12. The non-transitory computer-readable media of claim 1, wherein the holistic primacy score is computed as:
holistic primacy score=(D+R+C+F)*(α*β*γ)
where D is a quantification of diverse banking features of the financial institution that the customer engages with via the account,
where R is a quantification the various categories of transactions for which the account is used,
where C is a completeness score determined from an inferred probability that each particular category of transaction is likely to be included in the transactional-related information for the account,
where F is a quantification of any additional financial institutions included in the transactional-related information for the account,
where α is a technology centricity score calculated for the account,
where β is a cohort benchmarking of a total dollar transaction amount for the account, and
where γ is a proportion of dollar amount transacted on each particular category by the account.

13. The non-transitory computer-readable media of claim 1, wherein the at least one action includes giving the customer preferential treatment at customer interaction touch points of the financial institution.

14. The non-transitory computer-readable media of claim 1, wherein the at least one action includes prioritizing the customer for receiving one or more new product offers of the financial institution.

15. The non-transitory computer-readable media of claim 1, wherein the device is further caused to:
determine whether the customer has any additional accounts with the financial institution; and
compute the holistic primacy score for each of the additional accounts.

16. The non-transitory computer-readable media of claim 15, wherein the device is further caused to:
compute a combined holistic primacy score for all accounts of the customer with the financial institution, using combined transactional-related information for all of the accounts.

17. The non-transitory computer-readable media of claim 16, wherein the combined transactional-related information excludes transactions that occurred between two of the accounts.

18. The non-transitory computer-readable media of claim 16, wherein the device is further caused to:
perform at least one additional action in association with the customer, based on the combined holistic primacy score.

19. A method, comprising:
at a computer system:
identifying an account of a customer with a financial institution;
accessing transactional-related information for the account;
computing a holistic primacy score for the account, using the transactional-related information, the holistic primacy score holistically quantifying a primacy relation of the customer with the financial institution; and
causing at least one action to be performed in association with the account, based on the holistic primacy score.

20. A system, comprising:
a non-transitory memory storing instructions; and
one or more processors in communication with the non-transitory memory that execute the instructions to:
identify an account of a customer with a financial institution;
access transactional-related information for the account;
compute a holistic primacy score for the account, using the transactional-related information, the holistic primacy score holistically quantifying a primacy relation of the customer with the financial institution; and
cause at least one action to be performed in association with the account, based on the holistic primacy score.
